(19) United States
(12) Patent Application Publication
(10) Pub. No.: US 2013/0018494 A1
(43) Pub. Date: Jan. 17, 2013

(54) SYSTEM AND METHOD FOR MOTION ANALYSIS AND FEEDBACK WITH ONGOING DYNAMIC TRAINING ORIENTATION DETERMINATION

(71) Applicant: Alexander Andre Amini, (US)

(72) Inventor: Alexander Andre Amini, (US)

(21) Appl. No.: 13/183,306

(22) Filed: Jul. 14, 2011

(51) Int. Cl. A63B 69/00; G06F 19/00

(52) U.S. Cl. 700/91

(57) ABSTRACT

A physical skills training system in which motion sensor data is collected and analyzed under dynamic training conditions, for the purpose of automatically identifying the type of motion being attempted, assessing said motion, and providing real-time feedback to the user so the user may adjust their subsequent orientations and movements without interruption of normal game play. The system operates under ongoing, dynamic training sessions wherein the user may continuously move about a field of play and select from a variety of positions and motion types, in addition to stationary practice scenarios. The system provides a calibration mode, in which a user may create optimum, user-specific reference profiles, which are stored in the computer, and a measured play mode in which user movements and orientations are continuously assessed against the reference motions and feedback is provided in real-time.

### TECHNICAL FIELD

The present invention relates to the field of motion sensing devices for enhanced training of physical skills, and more particularly to the real-time analysis of and feedback to spatial orientation and inertial motion for dynamic training conditions.

### BACKGROUND ART

As sensors become dramatically smaller and less expensive, the applications of such sensors to enhanced training of physical skills are proliferating. Examples of sensors used for enhanced physical training include video and audio capture sensors, wireless inertial measurement units (WIMU) capturing spatial orientation and motion, and physiological sensors capturing respiration rate, heart rate, temperature, and other indicators of physical exertion.

U.S. Pat. No. 5,233,544 discloses a swing-analyzing device in which acceleration measurement sensors are attached to sports equipment, such as a golf club, so that features of the swing, such as torque, can be calculated and provided as feedback to the player by an audio or video representation of the feature. U.S. Pat. No. 5,694,340 discloses a similar acceleration-sensitive apparatus, but extends the state of the art by comparing the measured motion to a reference motion captured from a more accomplished player, and provides real-time audio and video feedback that is representative of the deviations of measured motion from the reference motion. The term “real-time” is used in this disclosure to refer to feedback that is provided as the user is performing a measured motion, or within 10 seconds thereafter. Both U.S. Pat. Nos. 5,233,544 and 5,694,340 target stationary practice scenarios where the objective is to repeat and refine a specific motion, such as a golf swing.

However, many physical skills training scenarios are often highly dynamic, requiring the player to continuously select from a variety of motion types, for example to respond to field position, opponent assessment, or ball trajectory. For example, in tennis, a player actively moves from forehand flat strokes, to forehand topspin strokes, to backhand volleys, and a variety of other strokes. For the game of golf, a player may chose from pitch shots, flop shots, chips, putts, and other swings. Thus, it would be highly desirable to have a motion analysis and feedback system capable of handling the dynamic nature of physical skills training. Neither U.S. Pat. No. 5,233,544 nor 5,694,340 include capabilities for responding to dynamic training conditions, and thus are insufficient to address a broad class of training scenarios.

In recent years, there has been significant attention to advancing the sensors used to capture orientation and movement data, including multi-sensor devices that combine accelerometers, gyroscopes, and magnetometers. U.S. Pat. No. 7,689,378 discloses a highly miniaturized, lightweight, microelectromechanical (MEMS) device capable of sensing 6 degrees of freedom motion of single or multiple axes rigid body in 3 dimensional space, plus initial spatial orientation. In U.S. Pat. No. 7,689,378, sensors are attached to the sports equipment (such as a golf club) and to the player (such as the player's arms and legs), and a computer analyzes sensor data and provides feedback based on deviation from a reference stroke. The user may manually select the reference shot to which their motions should be compared. However, like previous patents, U.S. Pat. No. 7,689,378 also does not include capabilities for responding to dynamic training conditions, and thus is also insufficient to address dynamic physical skills training scenarios.

Motion analysis and feedback for dynamic training conditions requires determining the orientation and type of motion being attempted on an ongoing basis. In tennis training scenarios, the type of motion would be the type of stroke, such as forehand flat or forehand topspin. In rehabilitation training scenarios, the type of motion might be based on the task to be accomplished, or the muscle group to be stretched or strengthened. “Combining Inertial and Visual Sensing for Human Action Recognition in Tennis” by O'Conaire, et al., discloses a system and algorithms for combining inertial and visual sensing of tennis strokes, however targets information search and retrieval scenarios as opposed to real-time training scenarios, and thus is limited to distinguishing classes of strokes, i.e., forehands, backhands, and serves; it does not distinguish stroke types, such as forehand flat versus forehand topspin strokes, which characterize the technique being employed, and does not target features needed for dynamic training systems. For dynamic training scenarios, it is desirable to distinguish and assess technique; it is insufficient to distinguish only classes of motion.

Therefore, there exists a need for a system and method for motion analysis and feedback under ongoing, dynamic training conditions.

### SUMMARY OF INVENTION

The present invention addresses the need for automated, real-time assessment of and feedback on user technique under dynamic training conditions, for the purpose of enhanced training of physical skills.

The present invention is a physical skills training system in which sensor data is collected and analyzed under dynamic training conditions, for the purpose of identifying the type of motion being attempted, assessing said motion, and providing real-time feedback to the user so the user may adjust their subsequent orientations and movements.

In a preferred embodiment, the present invention includes one or more sensors, each sensor capable of capturing data to measure the motions and orientations of a user, and of communicating the sensor data to a processing unit for analysis; a computer capable of receiving said sensor data and user input on training system configuration, executing a computer program to process said sensor data, and transmitting a indicator signal to the user as feedback; and a computer program capable executing on the computer to analyze the sensor data under ongoing dynamic training conditions, wherein a user may select from a plurality of positions and motion types, and to produce an feedback signal to indicate deviations of the measured motion from a reference motion, where the reference motion profile is automatically selected by the computer program based on data from the measured motion. The preferred embodiment includes a Measured Play mode, in which the user attempts physical skill training under normal, dynamic training conditions; and a calibration mode, in which a player creates optimum, player-specific reference profiles, which are stored in the computer. In calibration mode, the user performs the correct orientations and movements for a plurality of motion types, so that reference profiles may be captured, stored, and used during Measured Play mode to detect deviations from the correct movements and orientations and provide feedback to improve one or a plurality of movements and orientations.

In another preferred embodiment, the present invention may also include sensors that collect game ball or opponent tracking data in appropriate sports training scenarios, such as for tennis or baseball. In this alternate preferred embodiment, data from the game ball tracking sensors is also sent to the computer for analysis along with the sensor data collected for the user. The addition of external tracking sensor data enables a richer assessment and feedback, for example by incorporating the effect of the applied movement and orientation on the game ball.

In yet another preferred embodiment of the present invention, the computer program also stores stroke selection, accuracy data, and feedback data throughout the training session such that a report comprising a summary of performance throughout the complete training session may be generated for retrospective analysis of the training session. In this alternate preferred embodiment, the user may select from a plurality of summary and detail report components. The addition of the retrospective analysis report is to allow the user and/or their coach to review the performance over the full training session and components of the training session, and to compare performance over multiple training sessions.

An advantageous effect of the present invention is that by addressing dynamic training and game play scenarios, the user is being trained under conditions more representative of the real world, as opposed to stationary practice scenarios.

Another advantageous effect of the present invention is that it does not require the user manually specifying the type of motion they are attempting, but instead uses sensor data to detect the type of motion being attempted and assesses the user according to a reference profile for that motion.

Another advantageous effect of the present invention is that the assessment and feedback is based on actual measurements of the user, as opposed to subjective assessments by a human trainer.

Another advantageous effect of the present invention is that the system can provide assessment and feedback based solely on data from wireless inertial measurement units (WIMUs) which are inexpensive, small and easily worn by the user, and portable (i.e., do not require a fixed infrastructure).

Another advantageous effect is that the feedback can be delivered solely as one or more of: an audio signal, a video display, or as a physical signal (e.g., vibration), such that the user does not need to interrupt the flow of their training program, which may be very fast-paced.

Yet another advantageous effect is a user can use calibration mode to capture user-specific reference profiles. As the user's abilities improve, the user may chose to re-enter calibration mode to capture improved reference profiles. A user may choose to use their own reference profiles, or those of a more skilled player.

More advantageous effects of the present invention will become obvious from the drawings and ensuing descriptions.

### BRIEF DESCRIPTION OF DRAWINGS

FIG. 1 depicts the motion sensing and feedback system configured with a single WIMU, which transmits data via wireless communications to a base station, which is connected to the computer.

FIG. 2 depicts the motion sensing and feedback system configured with a single IMU integrated with the processor and storage, such as in a smartphone or personal digital assistant (PDA).

FIG. 3 demonstrates users utilizing the single WIMU sensor configuration and the integrated IMU configuration.

FIG. 4 is a flow chart of the computer program that controls the motion analysis and feedback.

FIG. 5 details the flow chart for the Calibration portion of the computer program that controls the motion analysis and feedback.

FIG. 6 details the flow chart for the Assess Motion portion of the computer program that controls the motion analysis and feedback.

FIG. 7 details the flow chart for the Collect Stroke Sample portion of the computer program that controls the motion analysis and feedback.

FIG. 8 provides the menus displayed by the computer program that controls the motion analysis and feedback.

FIG. 9 illustrates placement of additional sensors that may optionally be used in the present invention.

FIG. 10 details the flow chart for the train and test reference profiles procedure.

FIG. 11 and FIG. 12 detail key definitions of variables used to calculate the features in FIG. 13.

FIG. 13 details how each of the feature values that make up the profile for a single sample stroke are computed.

FIG. 14 provides example rules and resulting motion adjustment feedback for tennis training.

### DESCRIPTION OF EMBODIMENTS

In the preferred embodiment, the present invention includes one or more sensors, each sensor capable of capturing data to measure the motions and orientations of a user, and of communicating the sensor data to a processing unit for analysis; a computer capable of receiving said sensor data and user input on training system configuration, executing a computer program to process said sensor data, and transmitting a indicator signal to the user as feedback; and a computer program capable executing on the computer to analyze the sensor data under ongoing dynamic training conditions, wherein a user may select from a plurality of positions and motion types, and to produce a feedback signal to indicate deviations of the measured motion from a reference motion, where the reference motion profile is automatically selected by the computer program based on data from the measured motion.

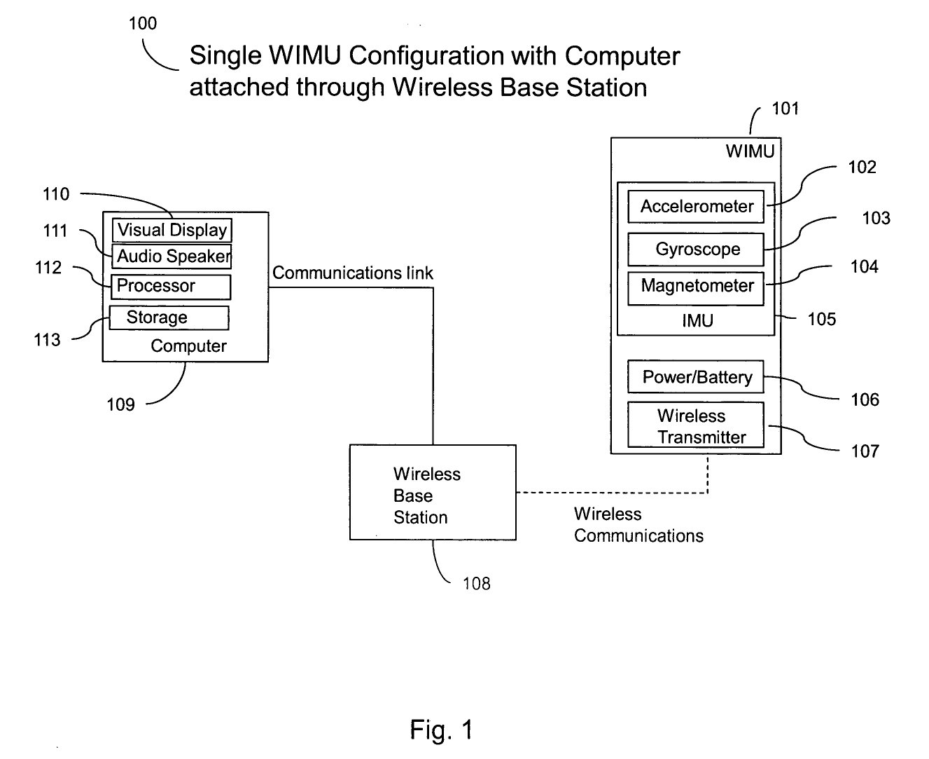

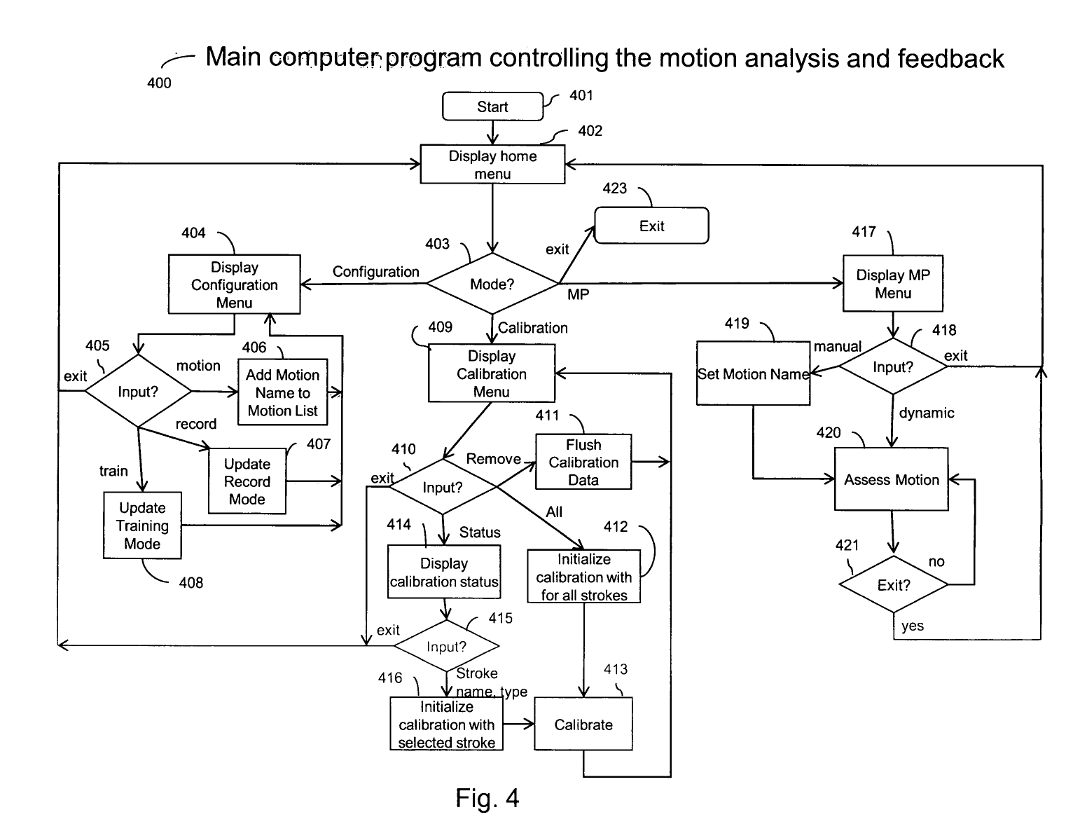

The invention description begins with a basic discussion of the hardware involved, and then details the computer software invented. FIG. 1 depicts the preferred embodiment (100) configured with a single WIMU (101), which transmits data via wireless communications to a base station (108), which is connected to the computer (109). Those skilled in the art will understand that the base station (108) may alternatively be a wireless network router, or other device capable of sending and receiving wireless transmissions. The WIMU includes an accelerometer (102), which is a sensor to detect changes in acceleration (changes in velocity) along the X, Y, or Z axis. The WIMU also includes a gyroscope (103), which is a sensor to detect orientation in 3 dimensions, and tri-axis magnetometer (104), which measures the strength and direction of the earth's magnetic field and can be fused with accelerometer and gyroscope data to help compensate for drift. The accelerometer, gyroscope, and magnetometer together are referred to as the Inertial Measurement Unit (IMU) (105). The WIMU also includes a power supply (i.e., battery) (106) and a wireless transmitter (107). The WIMU samples readings from the gyroscope, magnetometer, accelerometer, and wirelessly transmits those readings, along with the timecode at which the sample reading was taken. All of the inertial readings are captured in analog and converted to digital signals for transmission. The base station (108) relays the IMU readings to the computer (109). The computer (109) includes a processor (112), which executes the program detailed in FIG. 4 to process the IMU readings, store reference profiles in the computer storage (113), and generate feedback, which can be shown on the visual display (110) and communicated by the audio speaker (111). Although this configuration shows only a single WIMU (101), the base station (108) and computer (109) are capable of receiving and processing sensor readings from other sensors (not illustrated).

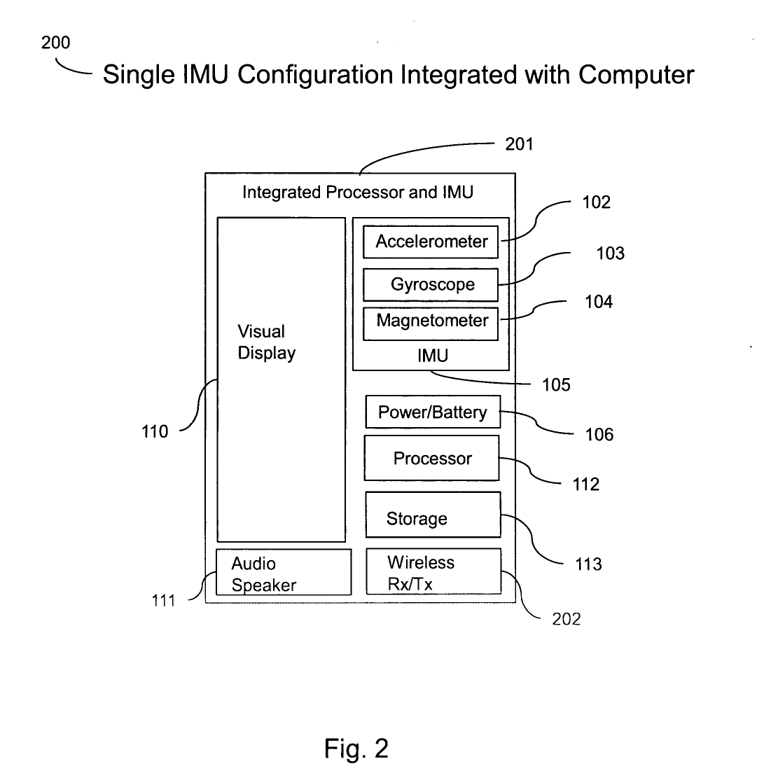

FIG. 2 illustrates an alternative hardware configuration (200) for the preferred embodiment with a single IMU integrated with the processor and storage (201), such as in a smartphone or personal digital assistant (PDA). As with the configuration in FIG. 1, the IMU (105) includes an accelerometer (102), gyroscope (103), and magnetometer (104), and the IMU (105) is integrated with a power supply (106). The configuration in FIG. 2 illustrates how the IMU (105) can also be integrated with a processor (112), storage (113), visual display (110) and audio speaker (111), which perform the same functions described for these components in FIG. 1. The IMU is integrated with the processor (112) and therefore able to communicate the IMU readings directly to the processor, without requiring wireless transmission. In this configuration, the wireless receiver/transmitter (202) enables receiving and processing sensor readings from other optionally included sensors (not illustrated).

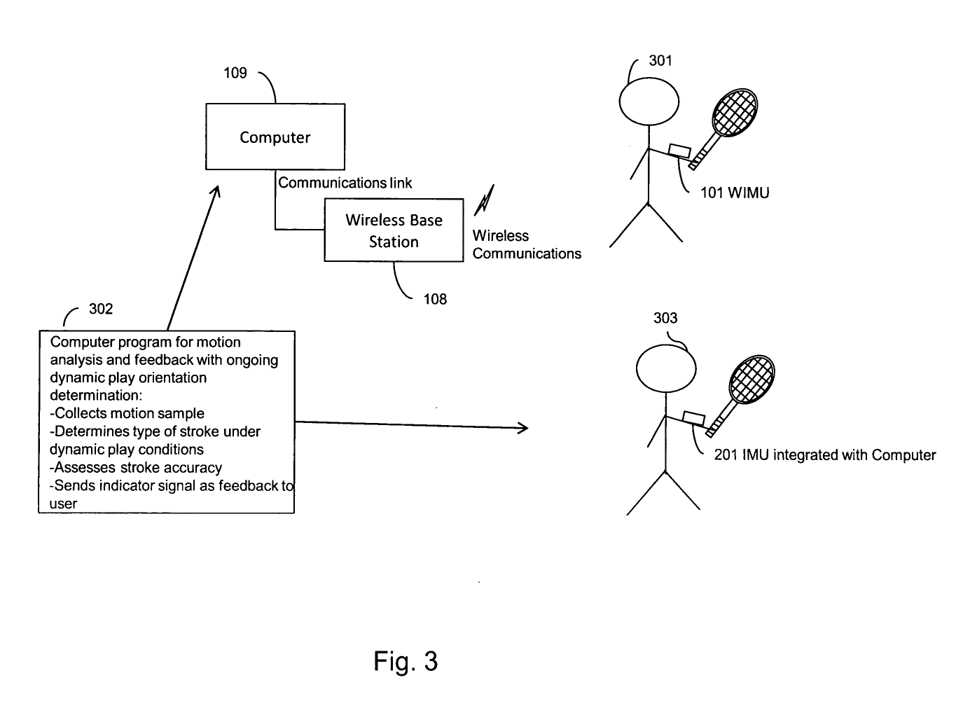

FIG. 3 demonstrates users utilizing the single sensor WIMU configuration and the integrated IMU configuration. As an example application, a user (301) holding a tennis racket is shown with the single WIMU (101) on their dominant arm. As a further example application, a user (303) holding a tennis racket is shown with the single integrated IMU (201) on their dominant arm. In either configuration, the computer program (302) will collect motion samples, determine the type of stroke being attempted under dynamic play conditions, assess the accuracy of the stroke technique, and generate an indicator signal as feedback to the user.

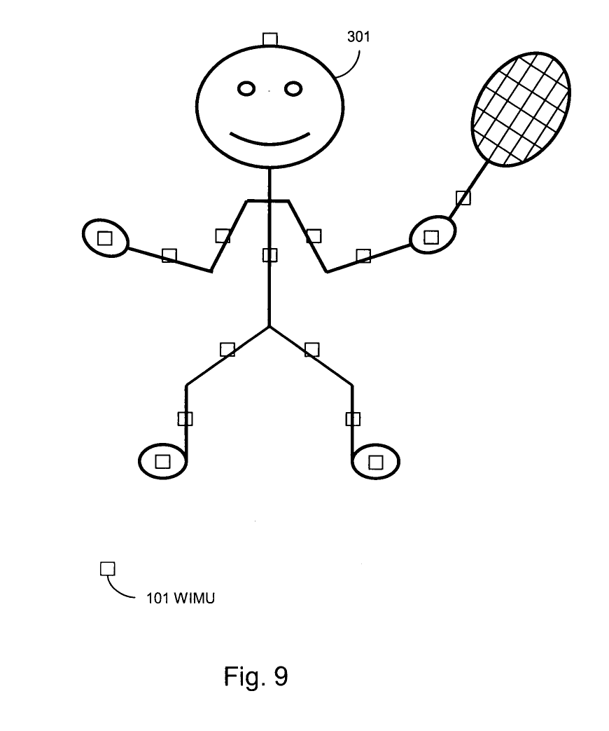

FIG. 9 illustrates how a plurality of WIMU (101) may be positioned to capture movement and orientation data from the user (301). Those skilled in the art will recognize that different subsets of the sensors displayed in FIG. 9 may be chosen according to a variety of reasons, including the motion being assessed, user comfort, and expense. FIG. 9 also illustrates the WIMU may be placed on the sports instrument, including tennis rackets, golf clubs, and hockey sticks.

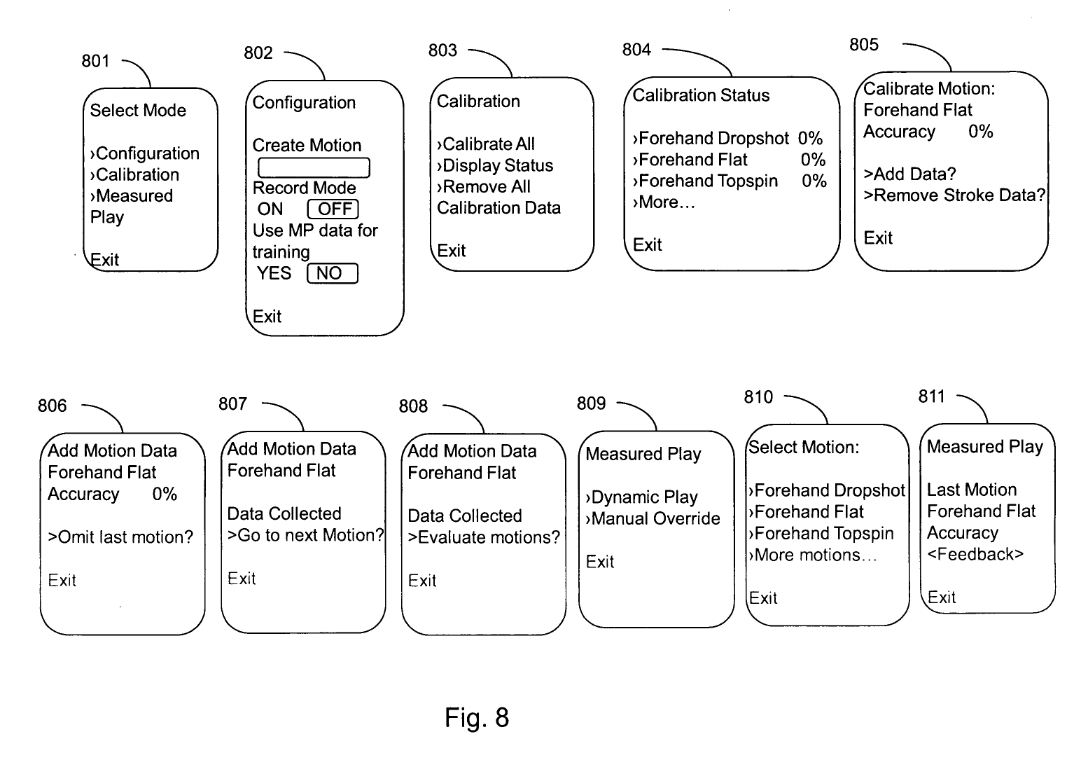

FIG. 4 is a flow chart of the main computer program that controls the motion analysis and feedback, and is generally designated 400. The menus to be displayed by the computer program (400) on the visual display (110) are illustrated in FIG. 8. The first action taken by the program after start (401) is to Display the home menu (402). The home menu (801) prompts the user to select from Configuration mode, Calibration mode or Measured Play (MP) mode, or to Exit. If Exit is selected, the program exits (423). Once the user responds by selecting a mode, the mode requested is evaluated (403) and the appropriate mode entered.

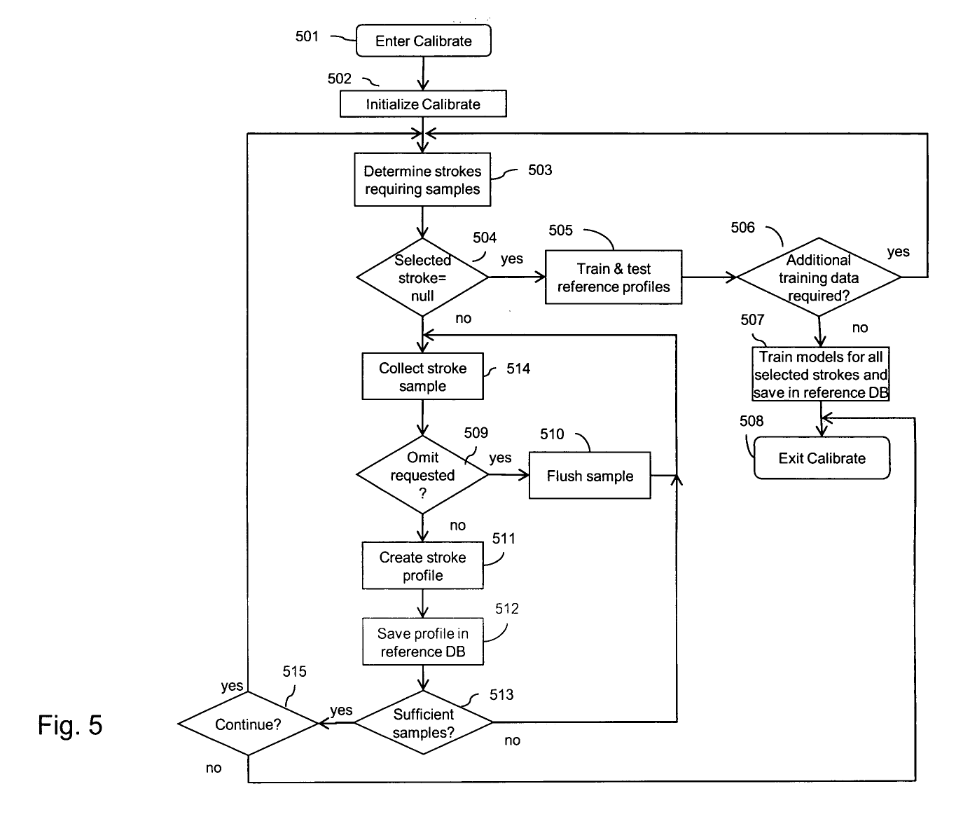

If Configuration mode is selected, the program will enter Display Configuration Menu (404). The displayed Configuration Menu (802) allows the user to create a new motion, alter Record Mode, alter Use MP data for training, or Exit. Once the user enters their input, the program will evaluate that input (405). If a new motion name is entered, the program will Add Motion Name to the Motion List (406) by first checking that the name is not already in use and if not, by creating an entry in the Reference Motion database (DB). The Reference Motion DB and its entries will be detailed in the discussion of FIG. 5. If the setting for Record Mode is altered, the program will update the record mode (407). When Record Mode is ON, the profiles captured in Measured Play and their feedback will be stored in a circular buffer. When Record Mode is OFF, the profiles captured during Measured Play are deleted after feedback is provided to the user. If the setting for Use MP data for training is altered, the program updates the training mode (408). When Use MP data for training is YES, motion profiles captured during Measured Play will be added to the Reference Motion DB. If Use MP data for training is NO, only motion profiles captured during Calibration are added to the Reference Motion DB. Adding profiles from Measured Play has the advantage of allowing the user to easily build a more comprehensive Reference Motion DR. Not adding profiles from Measured Play has the advantage of allowing the user to screen the profiles used for reference through Calibration mode.

If Calibration mode is selected, the program enters calibration mode and displays the Calibration menu (409) as illustrated in 803. After the menu is displayed, program awaits input (410). If the user selects “Remove All Calibration Data” from 803, the program will remove the calibration data for all strokes (411) and return to Display Calibration Menu (409). If the user selects “Calibrate All,” the program will update state to reflect that additional reference data for all strokes should be collected (412), and then will enter Calibrate (413). The detailed flow for the Calibrate (413) procedure is provided in the description for FIG. 5. If the user selects “Display Status” the program will display calibration status for all strokes (804) and allow the user to select a specific stroke (415). If the user selects a specific stroke, detailed calibration status will be displayed (805) and the user will be allowed to choose between adding additional calibration data for that specific stroke or starting a fresh set of reference data for that stroke by first removing existing stroke data. Once the user selects the stroke and whether new calibration data should be added to the existing reference DB or the existing data should be removed, that input is sent to Initialize calibration with selected stroke (416), which updates program state by removing existing reference data (if requested) and setting the stroke name. The program then enters Calibrate (413). The detailed flow for the Calibrate (413) procedure is provided in the description for FIG. 5. Once Calibrate (413) is complete, the program returns to Display Calibration Menu (409) in case additional calibration is desired. The user may chose to exit Calibration mode from either Display Calibration Menu (409) via 410, or Display Calibration Status (414) via 415.

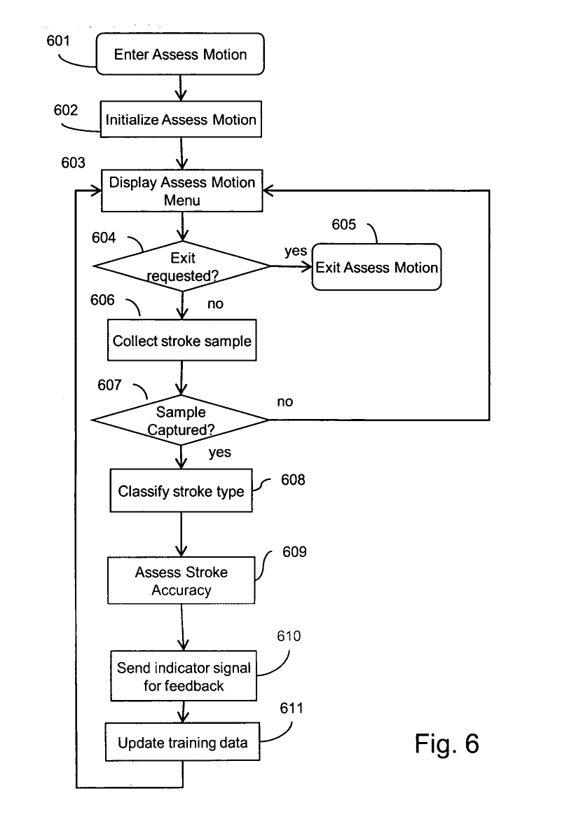

If Measured Play is selected from the menu in 801, the program enters Display MP Menu (417) in which the program displays the Measured Play menu (809), and awaits input (418). From 809, the user may chose to enter Dynamic Play mode (420) or to set a specific motion to be analyzed (419). If Dynamic Play (420) is entered, the program will enter the Assess Motion (420) procedure. A detailed explanation of the Assess Motion procedure is provided with FIG. 6. If the user chooses to set a specific motion (419), the Select Motion menu (810) is displayed so the user may select a specific motion. The selected motion is saved in the program state before entering Assess Motion (420). If the user exits from the Assess Motion (421) state, they will be returned to the home menu (402).

FIG. 5 details the flow chart for the Calibrate procedure (413) of the computer program (detailed in FIG. 4) that controls the motion analysis and feedback. The objective of Calibrate is to capture sufficient data such that when the user enters Measured Play mode, the program can: 1) determine with high accuracy whether measured motions are of a given shot type, 2) assess deviations from the measured motions of correct performances of that shot type, and 3) provide feedback so the user can improve motion. Assessing a given shot type and deviations requires sufficient performance data of the shot type under consideration, as well as performance data from incorrect performances, including other shot types and incorrect performances. FIG. 5 illustrates how the program in this invention collects this performance data and assesses whether it has sufficient performance data to enable high accuracy assessments during Measured Play.

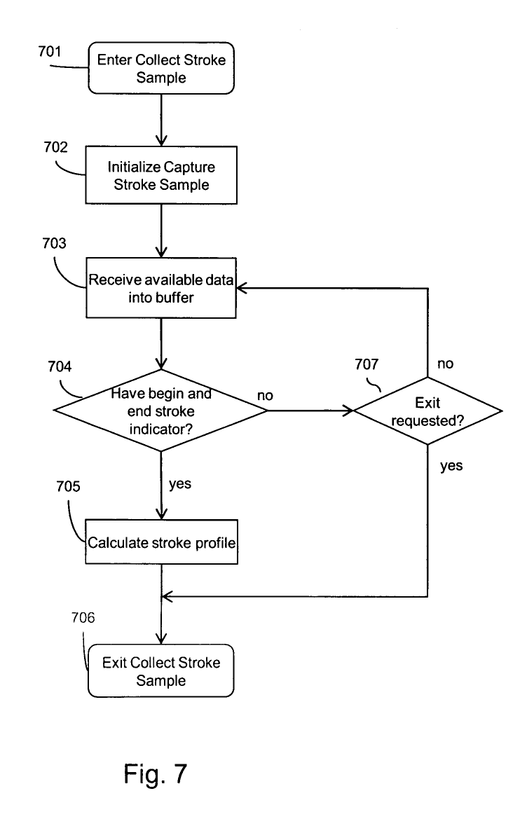

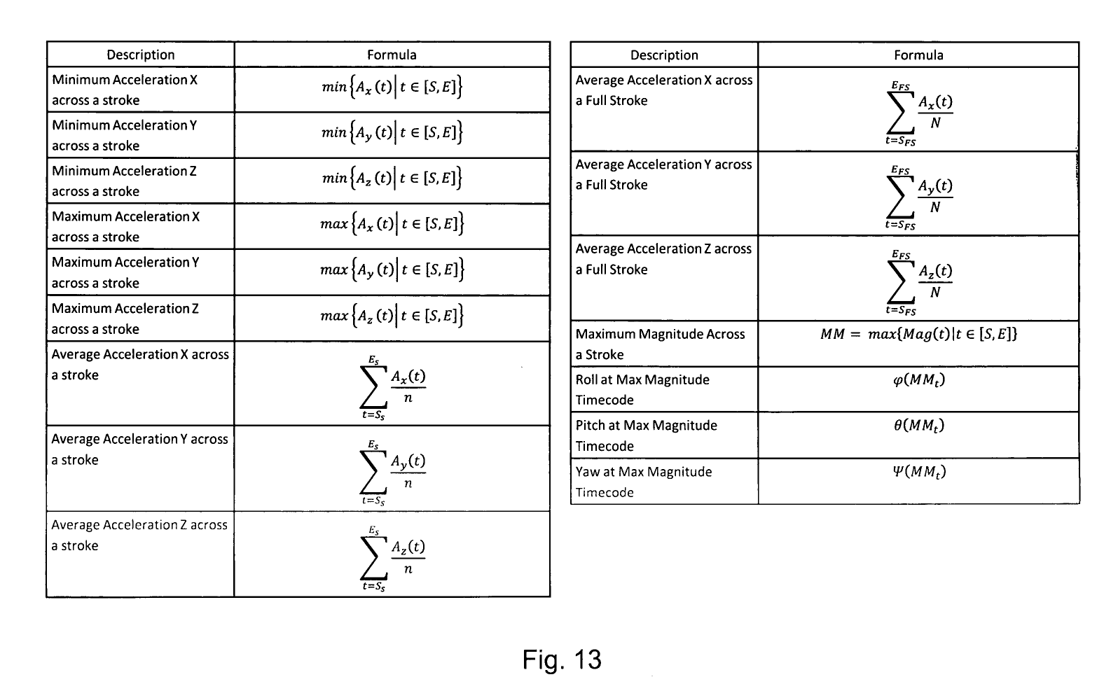

The program enters Calibrate at 501, and Initializes Calibrate (502) by setting internal state to the user specified strokes to be calibrated and by creating temporary buffer space to hold incoming sensor data to be evaluated. The program will then Determine strokes requiring samples (503) by checking which of the strokes to be calibrated have sufficient samples in the reference database to train and test models for that stroke and which require additional samples. If additional samples are required, the program will Collect stroke samples (514), which is explained in detail in FIG. 7. While the program is collecting samples, it displays a menu (806) that shows the current calibration status and allows the user to choose to omit the most recently collected sample. If the user requests to omit the most recently selected sample (509), the sample will be flushed (510). If the sample is not omitted, a stroke profile is created (511). The stroke profile is a summarization of important features of the stroke that can be used to train a model representing the stroke and to assess deviations from the model. The stroke profile is described with FIG. 13.

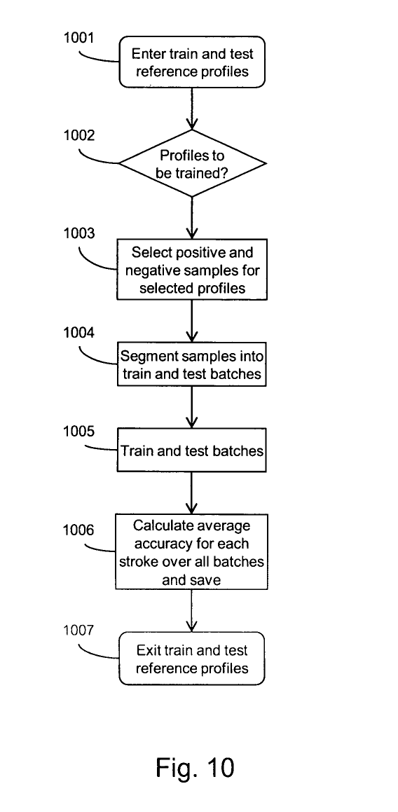

The profile created in 511 is stored in the reference database (512) so that it can later be used to train and test models in 505, and then the program tests whether sufficient samples have been collected (513) to support the train and test process in 505. The number of samples sufficient for train and test is dependent on the train and test method, which is described for FIG. 10. If sufficient samples have been collected the screen is updated to allow the user to go to the next motion (807) if additional motions require calibration, or to evaluate motions (808) if no addition motions require calibration. The user may also choose to exit calibration mode from 807 or 808. Depending on the user's choice from the menus 807 or 808, the program will Continue (515) by returning to Determine strokes requiring samples (503) or exit calibrate (508).

When Determine strokes requiring samples (503) determines additional samples are not required, the selected stroke will equal null (504) and then the program will Train and test reference profiles (505). The preferred embodiment for Train and test reference profiles (505) is explained in detail in FIG. 10. The results of Train and test reference profiles (505) are assessed to determine if Additional training data is required (506) to attain the accuracy required for Measured Play, and if not, models are trained for all selected strokes and saved in reference DB (507), and then Calibration mode is exited (508). If Additional data is required (506), the program returns to collect more data in Determine strokes requiring data (503).

FIG. 7 details the procedure for collecting a stroke sample. The procedure is entered at 701, and then proceeds to Initialize Capture Stroke Sample (702), which clears capture buffers and internal capture state. The program will continue to Receive available data into buffer (703) by reading data from the WIMU sensors into its internal buffers until a begin and end stroke indicator is detected. The preferred embodiment of the present invention tests for a begin stroke indicator and an end stroke indicator (704) by testing the magnitude of the accelerometer sensor from the WIMU positioned on the dominant arm of the user. Those skilled in the art will understand that additional sensor data and techniques may be used in computing a begin stroke indicator and end stroke indicator. If the wait for begin and end stroke indicators (704) is interrupted before the indicators are received, the program checks whether the user requested program exit (707) from the Measured Play status menu (811). If Exit is requested (707), the program moves to Exit (706), otherwise it returns to receive additional data (703). Once the begin and end stroke indicators are received, the program Calculates the stroke profile (705).

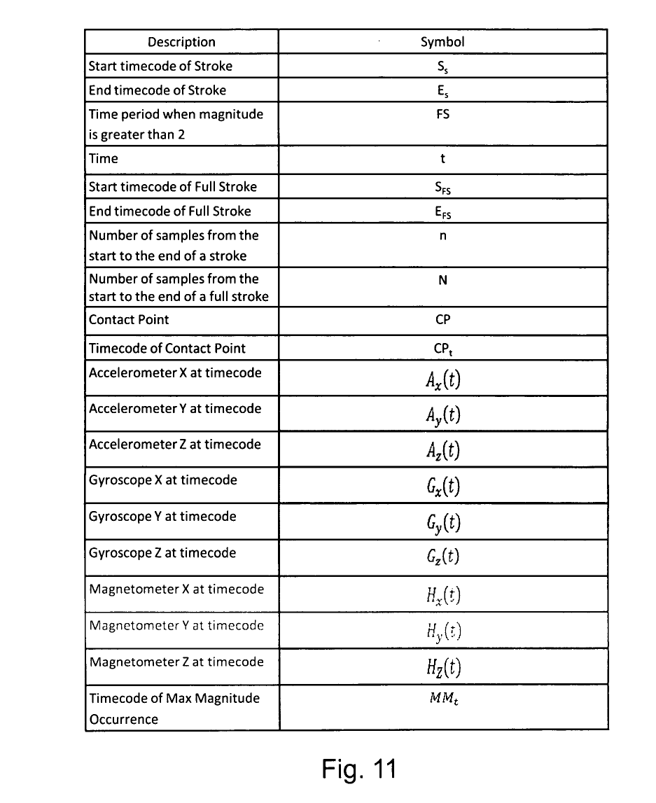

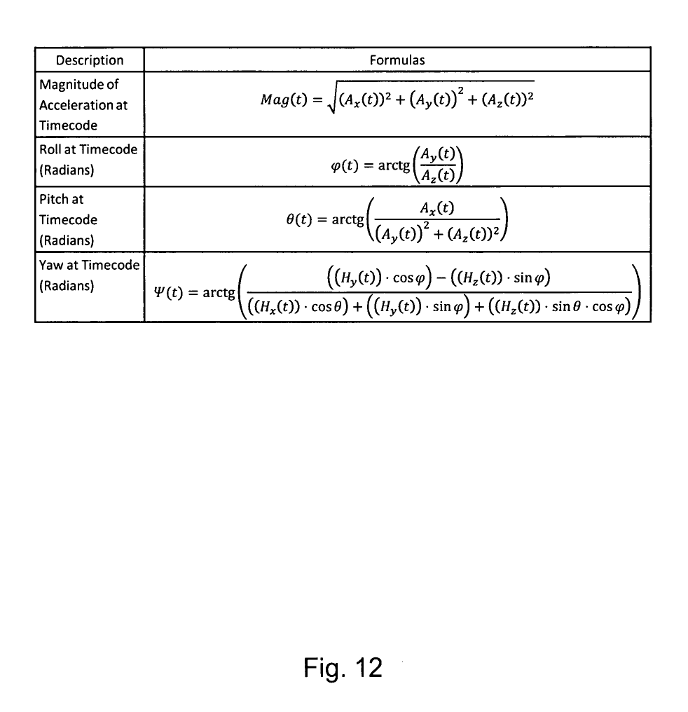

The stroke profile is computed from the WIMU sensor data collected during the performance of the stroke. FIG. 13 provides the features used to compute the stroke profile stored in the reference database in the preferred embodiment of the present invention. FIG. 11 and FIG. 12 provide definitions of variables used to calculate the features in FIG. 13. These features are specific to measured motions and orientations for tennis strokes, however those skilled in the art will understand that similar features specific to other sports, such as golf and hockey, can be used in this invention. In addition to the features computed for each stroke, each stroke profile includes the actual stroke type that was being performed. We refer to this actual stroke type as the ground-truth stroke type. Once the stroke profile is calculated, the Collect Stroke Sample procedure is exited (706).

FIG. 10 details the Train and test reference profiles procedure, which begins with Enter train and test reference profiles (1001). The program accesses the reference database to determine which of the strokes selected for calibration have sufficient reference profiles in the reference database (1002). The number of profiles required to train and test is dependent on the type of model to be trained.

The preferred embodiment of this invention uses a data mining technique called Support Vector Machines (SVM) to train and test a model for each stroke type. Additional information on SVM can be found in “An Introduction to Support Vector Machines and Other Kernel-based Learning Methods,” by Cristianini, et al [Cristianini]. Those skilled in the art will understand that other classification techniques, such as decision trees, and K-Nearest Neighbor (KNN) could be used to train and test models for the present invention. Additional information on decision tree and K-NN classifiers can be found in “A survey of decision tree classifier methodology,” by Safavian and Landgrebe [Safavian]; and “Nearest-Neighbor Methods in Learning and Vision,” by Shakhnarovish and Indyk [Shakhnarovish], respectively. In the following two paragraphs, we describe how a classification technique, such as SVM, can be used to calibrate models and assess performance against those models.

In training mode, SVM accepts samples that are labeled as positive and negative examples of the model to be trained. For example, if a model of the Forehand Flat stroke is being trained, then profiles for which the ground-truth stroke type is Forehand Flat would be labeled as positive samples and profiles of all other strokes would be labeled as negative samples. In the preferred embodiment of the present invention, the stroke profile, which is a list of feature values computed from the WIMU sensor data, is the sample provided to SVM. FIG. 13 details how each of the feature values that make up the profile for a single sample stroke are computed.

In test mode, SVM accepts samples for which the same features have been calculated and uses the trained model to classify the samples as positive or negative examples of the modeled stroke. The accuracy of the model is determined by comparing the positive or negative classification of each stroke profile to the ground-truth stroke type of the same stroke profile.

Once the procedure in FIG. 10 determines there are profiles available for training (1002), it selects the set of positive and negative samples for selected profiles (1003) from the reference database to be used for training a model for each stroke type. For each model to be trained, it Segments samples into test and train batches (1004). The present invention randomly selects 80% of the samples in each batch for training the model and then uses the remaining 20% for testing that model. Those skilled in the art will understand that other techniques for segmenting samples into batches may be used with the present invention. The program in FIG. 10 then uses SVM train mode to train a model and SVM test to test that model (1005). The average accuracy is computed for each model across all batches, and this accuracy value is stored in the reference DB with the model (1006). Finally, the train and test reference profiles procedure is exited (1007).

FIG. 6 details the flow chart for the Assess Motion portion (420) of the computer program that controls the motion analysis and feedback from FIG. 4. The program starts with Enter Assess Motion (601). To Initialize Assess Motion (602), the present invention updates the internal state of the Assess Motion procedure by allocating buffers for stroke data to be captured and assessed. Display Assess Motion Menu (603) displays the Measured Play status (811), including the last motion assessed, computed accuracy, and feedback. The user may chose to Exit Assess Motion (605) by requesting exit (604) from the Measured Play status (811). If exit is not requested, the present invention will attempt to Collect stroke sample (606). The procedure for Collect stroke sample (606) is explained in detail in FIG. 7.

When Capture stroke sample (606) completes, it returns an indicator of whether a complete stroke sample was received, and this indicator is tested in 607. If no sample was captured, the Assess Motion procedure returns to Display Assess Motion Menu (603). If a sample is captured, Classify stroke type (608) computes the features detailed in FIG. 13 to create a profile of the stroke and uses the models saved to the reference database during Calibrate (413) to determine stroke type. The preferred embodiment of the present invention uses SVM in test mode to test the computed stroke profile against the models. The sample is classified as the stroke type of the model that achieves the highest accuracy classification.

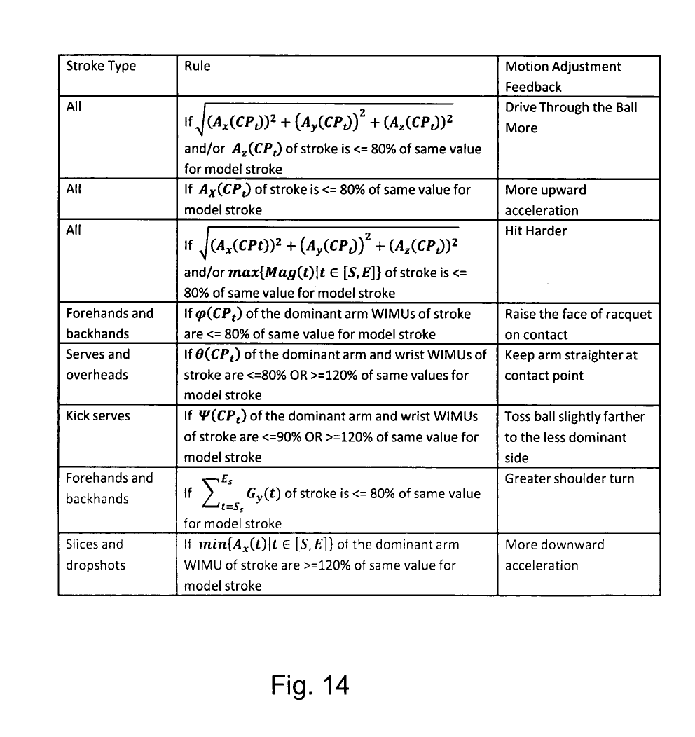

The Assess Stroke Accuracy (609) uses the accuracy achieved by the model with the highest accuracy as the stroke accuracy. The stroke type determined in 608 and accuracy determined in 609 are passed to 610 for inclusion in the feedback sent to the user. The preferred embodiment of the present invention includes a rules-based method for further analyzing the motion profile to recommend specific motion adjustments. FIG. 14 provides example rules and resulting motion adjustment feedback for tennis training. Those skilled in the art will understand how similar rules-based feedback applies to other training scenarios, such as baseball and golf. After providing user feedback, Update training data (611) optionally saves the most recently collected motion profile to the reference database, if Use MP data for training is enabled.

The feedback is displayed in the Measured Play status menu (811) and may also be communicated to the user via an audio signal. If Training Mode was enabled during Configuration, the profile for the captured stroke will be saved to the reference database. Program control then returns to Display Assess Motion Menu (603) so that the user can continue in dynamic play mode. The user may chose to look at the visual display of the Measured Play status (811), or to rely solely on the audio signal used to convey the same feedback information. Relying solely on the audio signal has the advantageous effect of allowing the user to minimize any visual distractions from their normal game play.

The above disclosure details how the present invention continually assesses the motions and orientations of a user during active and ongoing play scenarios, and how it provides feedback to enable the user to improve motions and orientations based on the unbiased sensor measurements. The present invention is also well suited to design variations. For example, depending on the application of the present invention, it may be desirable to also attach sensors that collect game ball or opponent tracking data. In this design variation, data from the game ball tracking sensors is also sent to the computer for analysis along with the sensor data collected for the user. For example, the court position at which ball-to-racket contact is made and the court position at which the ball makes court contact as a result of a stroke can be provided as a features in the stroke profile used to train and test models. The addition of external tracking sensor data enables a richer assessment and feedback, for example by incorporating the effect of the applied movements and orientations on the game ball.

In yet another design variation of the preferred embodiment of the present invention, the computer program also stores stroke selection, accuracy data, and feedback data throughout the training session such that a report comprising a summary of the complete training session may be generated for retrospective analysis of the training session. In the preferred embodiment, this report is in the form of an electronic document comprising text and images. In the preferred embodiment, the user may select from a plurality of summary and detail report components. Example summary components include the average accuracy over the course of the training session or of logical subdivisions of that session. Examples of logical subdivisions for the game of tennis are match, set, and game. Additional examples of summary components include a summary of motion type selection, average accuracy for that motion type, and most common feedback for that motion type. An example of a detail report component includes a table wherein each row represents a motion analyzed and represent important features of that motion, such Time of Motion Capture, Type of Motion, Accuracy, and Feedback.

While the particular dynamic motion analysis and feedback system described herein and disclosed in detail is fully capable of obtaining the goals and providing the advantageous effects herein before stated, it is to be understood that it is merely illustrative of the presently preferred embodiments of the invention and that no limitations are intended to the details of construction or design herein shown other than as described in the appended claims.

### CITATION LIST

### Patent Literature

| | | |
|---|---|---|
| U.S. Pat. No. 5,233,544 | 1993 | Kobayashi |
| U.S. Pat. No. 5,694,340 | 1997 | Kim |
| U.S. Pat. No. 7,689,378 | 2010 | Kolen |

### Non-Patent Literature

[O'Conaire] C. O'Conaire, D. Connaghan, P. Kelly, N. O'Connor, M. Gaffney, J. Buckley. Combining Inertial and Visual Sensing for Human Action Recognition in Tennis. ARTEMIS 2010—ACM International Workshop on Analysis and Retrieval of Tracked Events and Motion in Imagery Streams. October, 29, 2010. Firenze, Italy.
[Cristianini] Nello Cristianini, John Shawe-Taylor. An Introduction to Support Vector Machines and Other Kernel-based Learning Methods. 2000. Cambridge University Press.
[Shakhnarovish] Shakhnarovish, Darrell, and Indyk. Nearest-Neighbor Methods in Learning and Vision. 2005. MIT Press.
[Safavian] Safavian, S. R.; Landgrebe, D. A survey of decision tree classifier methodology. Systems, Man and Cybernetics, IEEE Transactions. May/June 1991. Sch. of Electr. Eng., Purdue Univ., West Lafayette, Ind.

1. A motion sensing and feedback system with ongoing active play orientation determination, comprising:
one or more sensors, each sensor capable of capturing user motion data including movements, orientations, and location, and of communicating sensor data to a computer for analysis; and
a computer capable of (1) storing previously captured profiles of reference motions, (2) processing incoming said sensor data from the user's measured motion, (3) transmitting an indicator signal during active play as feedback to the user on the measured motion; and
a computer program that executes on said computer and is capable of (1) analyzing the sensor data under ongoing dynamic training conditions, wherein a user may select from a plurality of positions and motion types for each motion performance, and (2) producing a real-time feedback signal to indicate deviations of each motion performance from one or more reference motions, where said reference motions are automatically determined by the computer program.

2. The system in claim 1, wherein the computer program further comprises a mechanism to analyze captured sensor data and to produce a report with a user-specified or default set of summary and detail information on motions, accuracy, and feedback over an entire training session.

3. The system in claim 1, wherein each of the said motion sensors comprises one or more of:
a tri-axis accelerometer to measure differential acceleration of the sensor;
a tri-axis gyroscope to measure differential rotation around the sensor; and
a tri-axis magnetometer to measure a local magnetic field vector at each motion sensor.

4. The system in claim 1, wherein one or more motion sensors communicate wirelessly with the computer.

5. The system in claim 1, wherein data may be further transmitted to a remote computer for additional processing and feedback.

6. The system in claim 1, wherein the indicator signal for feedback comprises one or more of: an audio signal, a visual signal, and a physical signal.

7. The system in claim 1, wherein the said computer and said sensors are integrated into a single unit that is attached to the user or training equipment.

8. The system in claim 1, wherein:
one or more additional sensors capture sensor data tracking user, ball, or opponent location; and
the computer program comprises a mechanism to use the said user, ball, or opponent location data to further analyze motion data and generate feedback signals to indicate deviations from said reference motions.

9. The system in claim 1, wherein the computer program further comprises a method of producing a real-time signal to announce to the player a type of motion to be taken by the user.
